(19) United States
(12) Patent Application Publication
(10) Pub. No.: US 2007/0282642 A1
(43) Pub. Date: Dec. 6, 2007

(54) Horizontal excess coverage

(76) Inventors: Bruce Bradford Thomas, Trumbull, CT (US); Lester Ware Preston, Darien, CT (US)

Correspondence Address: Bruce Bradford Thomas, 145 Lake Avenue, Trumbull, CT, 06611, US

(21) Appl. No.: 11/891,779

(22) Filed: Aug. 13, 2007

Related U.S. Application Data
(63) Continuation-in-part of application No. 10/647,078, filed on Aug. 22, 2003.

(51) Int. Cl. G06Q 40/00

(52) U.S. Cl. 705/4

(57) ABSTRACT

A method for underwriting and adjusting losses based on the losses paid by an insurance policy.

### CROSS-REFERENCE TO RELATED APPLICATIONS

This application is a CIP of application Ser. No. 10/647,078, entitled Secondary Loss Expense Coverage, filed on Aug. 22, 2003 by the present inventors.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to providing coverage for loss expenses that are difficult or impossible to insure.

2. Background of the Invention

Insurance is a means by which the risk of loss is contractually shifted from the insured to the insurer. Under this contractual arrangement, the insured pays a premium to the insurer for agreeing to bear some potential loss that the insured faces.

Underwriting

Not all potential losses are insurable and an insurer must expend significant efforts to ensure that applicants have met its standards. This process is known as underwriting. Although such standards encompass many elements, there are two elements that are of particular importance. The causes of loss that are covered by an insurance policy must be defined and the policy must carry a premium that is reasonable in relation to the potential for loss.

Because the terms of insurance are relatively complicated and the coverage definition is critically important to both the insurer and insured, extensive consideration is warranted. Since insurers have much greater expertise in this area, most insurance buyers use insurance agents and brokers to help them make good purchasing decisions.

Loss Adjustment

Substantiating insurable losses can be very expensive for both insureds and insurers. Insurers categorize their costs associated with determining whether losses occurred and to what extent they are covered under the insurance policies that they write as loss adjustment expenses.

In instances where coverage exists, claimants must spend considerable effort identifying and substantiating their losses. For large claims, it is not unusual for individuals and companies to hire their own adjusters and accountants to ensure that they get the most out of their insurance.

Loss Definition and Valuation

Insurance works best in instances where the definition of loss is obvious and the amount of loss is clear. If a loss is not easy to define or prove, it should not be insured by a policy that requires such proof, because it will result in unduly complex coverage terms, disagreements over coverage interpretation, and difficulties in proving and quantifying losses.

To be eligible to receive insurance payments, insurance buyers must be able to prove that they had losses and that those losses fit within the coverage definition of their insurance. Losses can be categorized in many different ways such as life, health, property, casualty, etc. More generally, losses can be categorized as being direct or indirect.

A direct loss is a loss where the insured peril is the proximate cause of the loss. For example, the direct loss of a factory due to a fire would be the cost of rebuilding the factory. The indirect losses would be all of the costs associated with the inconvenience of not having a workable factory. Direct losses, such as the physical cost of the buildings in this example, are typically much easier to estimate than indirect losses such as lost income or extra expenses that may result from such an event. Management and employees must spend time trying to recover from this event, and there is always a significant amount of opportunity cost that can never be adequately assessed.

Consider for example the loss of an automobile. Since it is a physical thing, it should be obvious that there was a loss and the extent of that loss. Nevertheless, the indirect costs (for example lost time and other expenses) associated with fixing or replacing the car are not typically covered by insurance. Similarly, insurance may cover the direct cost of paying for and defending against a liability claim, but it typically would not cover the costs necessary to restore an entity's reputation via an advertising program or to institute new practices and procedures.

Indirect losses vary in size depending on the specifics of the loss, but they occur with every type of insurable loss. Although insurance can cover certain limited types of indirect costs such as the loss of income (business interruption) and “extra” or “expediting” expenses that are necessary to return a business to normal after a loss, companies and individuals are not typically insured against majority of indirect losses because these losses are often too difficult to define in advance or prove after the fact to make an insurance transaction economically viable for both insurers and insurance buyers.

Furthermore, policyholders often have considerable discretion over indirect losses, making them impossible to quantify and subject to significant moral hazard. Since indirect losses are becoming an ever larger part of most companies' loss experience, it is no wonder that companies are increasingly frustrated with insurance.

One consequence of having a large loss is that an entity's future insurance premiums may increase. Since this additional cost is not subject to the discretion of the insured, it is relatively easy to finance. To the extent that an insured is interested in purchasing this kind of coverage, an insurance company could just charge some extra amount of premium to smooth the eventual cost of the premium increase. This financing mechanism is similar to a heating oil company that charges its customers more than it would otherwise charge in the summer, when oil prices are lower, and less than it would otherwise charge in the winter. This smoothes the price variation of oil so customers can more accurately budget for their heating cost.

For clarity, we are defining “collateral losses” to be a subset of indirect losses that have not been covered by traditional insurance because they are subject to the discretion of the insured. Collateral losses arise from insured events but are too difficult to define, prove, or measure to be covered by an insurance policy in the traditional way. Collateral losses include but are not limited to such things as: lost income, lost productivity, credit losses, additional borrowing costs, reputation maintenance expenses, claim expenses, accounting expenses, legal costs, consulting, and other types of discretionary expenses.

Moral Hazard

Because insurance limits are often over a hundred times more than insurance premiums, the insured's personal habits, morals, and attitude toward losses are very important. Insurers attempt to reduce moral hazard by instituting deductibles, coinsurance clauses, and reduce insurable limits. This may dissuade applicants who are more predisposed to losses from selecting a given insurer, and it helps change attitudes toward potential losses by forcing insureds to retain a larger share of those losses. Unfortunately, each of these measures also means that the insured is never fully compensated for a loss. While insurers may have reduced moral hazard, they have done so at the cost of making insurance less valuable to the insured.

Agreed Value

Even when it is relatively easy to substantiate that a direct loss has occurred, it is not always easy to determine the value of that loss. In relatively simple cases, the insured must show receipts, appraisal documents, or other evidence that would substantiate value. Often appraisers must be called in to provide their opinions about value.

In many cases, the value of something may be open to interpretation. One technique that insurers have employed in circumstances where losses are relatively easy to substantiate but difficult to value, is to objectify the loss value at the time a policy is written.

Life policies operate on the principal of agreed value. Rather than attempt to dispute how much a life is worth after it is over, insurers and insureds agree to a certain value up-front and base premiums on that value. This principle is also employed for certain very special risks such as the value that was placed on Betty Grable's legs or the successful launch of an Ariane rocket.

Inventory or cargo insurance is another example of where this principle has been applied to direct losses. With inventory it is generally accepted that different types of companies have incurred costs that are greater than the purchase price of the goods they own. From an economic perspective, the value is not the invoice cost but the replacement cost of the inventory at a particular stage in the production, transportation, and retailing process.

Rather than dispute this point, insurers and insureds often agree to a stated percentage above the purchase price of the goods. Under this arrangement, the insurer and the insured increase the limit of the insurance to some commercially reasonable amount, and the price of this coverage is increased to take account of the higher loss valuation.

Thus, if the insured chooses to buy this extra coverage in an amount of 10% and has a loss, the insured will be paid the invoice amount for the goods that were lost plus an additional 10%. In this example, it is easy enough to define the potential losses in advance and to prove those losses after the fact, but the use of the agreed value principle helps eliminate the expense of having to measure the loss.

Transaction Costs

Selecting coverage, defining losses, and meeting other insurance requirements can be very burdensome for both insurers and their customers. In the year 2001, US property and casualty insurers spent more than $133 billion dollars in brokerage commissions, underwriting, and loss adjustment expenses. This amount represents approximately 39% of the premium dollars that they earned in that year.

Moreover, this amount does not reflect the significant costs that insurance buyers expended in getting coverage, substantiating their losses, and proving that those losses were covered under their insurance policies. The amount of time and expense that is involved in buying insurance and collecting on it can be very discouraging to insurance buyers, and it places new burdens on them when they are least able to deal with them.

Furthermore, it is not unusual for there to be disputes about what the cause of a loss was or if it is covered by insurance, and many claimants initiate litigation proceedings against their insurers to force them to pay. The inability to define in advance all the losses that will be covered by the policy makes it difficult for the insurance buyer to assess the value of the insurance policy and makes it equally hard on insurers to determine a fair premium.

The high cost of underwriting and loss adjusting are also huge deterrents to companies that would like to finance insurable risk. In effect, the large transaction costs associated with insurance represent a huge barrier to entry that discourages third parties from offering coverage and increases the cost of capital that is necessary to finance risk.

Reinsurance

Reinsurance is essentially insurance for insurance companies. Reinsurance enables insurers to buy protection against certain potential losses by paying premiums to another insurer called a reinsurer. Using this mechanism, an insurer can reduce its risk of loss by ceding risk on an individual basis (facultative reinsurance) or on a large number of risks (automatic reinsurance).

Reinsurance can be classified as either proportional or non-proportional in relation to the underlying insurance policies. Under proportional reinsurance, a reinsurer agrees to assume some proportionate share of the premiums and losses of the underlying insurance policies.

Quota share reinsurance is a type of reinsurance that is both automatic and proportional. Under this arrangement, a reinsurer agrees to accept a given percentage of every risk within a certain defined category that an insurer writes in return for the same percentage of premium. Thus, in the case of 30% quota share, a reinsurer must pay 30% of any loss that is sustained on exposures within a given risk class in return for receiving 30% of the premiums for that same class of risk.

By employing a coverage mechanism that is proportional and automatic, insurers and reinsurers can reduce the underwriting and loss adjustment expenses that would otherwise be a part of their reinsurance agreements. However, this technique is only used to share risks between insurers and reinsurers. The original insured is not involved in reinsurance transactions and gains no additional coverage as a result of it. Moreover, the insurer is obligated to pay the insured regardless of whether the reinsurer pays the insurer.

Derivatives

Derivatives are financial contracts whose pay-offs are based on the performance of an underlying asset, index, or reference rate. They include options, futures, forwards, and swaps. Derivatives may be used to speculate, by permitting investors to assume additional risk, or to hedge risk, by allowing entities to transfer risk to other market participants.

As a risk management tool, derivatives are commonly used to reduce market-based risks such as interest rates, currency rates, or price levels of commodities and financial assets. Because these types of risk are exogenous to any particular entity, they have certain qualities such as transparency and non-manipulability that permit them to be traded in a standardized and highly efficient way.

Generally speaking, companies can use financial contracts to hedge against changes in market rates and prices but not against their own idiosyncratic risk. Companies must manage these risks by themselves or, to the extent they can, buy insurance.

Securitization

Attempts have been made to standardize certain types of insurable risks, embed those risks in financial instruments, and trade them. During the 1990's, a number of efforts were made to develop catastrophe indices and related financial contracts that could be used to transfer the more exogenous parts of the insurance industry's loss experience. The most notable of these efforts were undertaken by the Insurance Services Office, Property Claims Services, and IndexCo. Each of these companies produced and published catastrophe indices that were the basis for derivative contracts that were traded on either the Chicago Board of Trade or the Bermuda Commodities Exchange.

Such large-scale efforts to standardize insurable risk have largely been abandoned. However, a number of insurers and reinsurers have had some limited successes in creating bond instruments and other types of securities that have enabled them to transfer a portion of their insurable risks to others. These transactions typically involve transferring catastrophic risks such as earthquake and hurricane losses that are considered to be substantially outside of any particular insurer's and reinsurer's ability to control or influence. These transactions share some similarities to reinsurance, and it is not uncommon for reinsurers to be some of the largest investors in these deals.

None of these securities were designed to offer new forms of coverage or risk transfer options to a single insured that is not actively engaged in the insurance or reinsurance business. Moreover, these types of transactions have not been based on a single policy between an insured and an insurer. In addition, there is no standard relationship between the price that is charged and the coverage that is provided by a securitization in relation to the underlying insurance policies.

Instead, the price of a securitization is a function of how well a given transaction is received by the market at the time a deal is executed as well as the coverage that is provided. Although coverage may be described in a variety of ways, it is often begins at some relatively high loss threshold and typically includes multiple provisions that must be satisfied before any payments are due. Furthermore, securitizations are often “funded” to eliminate credit risk. This necessitates the inclusion of a large interest rate component that is typically absent in most insurance transactions which are often highly levered.

New Approach Needed

Given high transaction costs and the necessity of defining and proving losses, it becomes clear that insurance is a risk financing solution with significant limitations. Insurance proceeds are supposed to restore the policyholder to the same exact position that existed before the loss occurred. In practice, this is impossible. Collateral losses, deductibles, coinsurance, and coverage limits mean that the insured will never be fully recompensed for their losses. Clearly another approach is needed. Such an approach would permit more of the uncertainty associated with insurable losses to be objectified and would reduce the transactional burdens that are placed on the parties to an insurance contract.

### OBJECTS AND ADVANTAGES

The object of the invention is a method and process for insuring or financing expenses associated with insured loss events that we call Horizontal Excess Coverage. This method provides a new way to insure indirect loss expenses that are currently expensive to insure. It also makes it possible to insure collateral losses that are too difficult to define, prove, or measure to be covered by an insurance policy in the traditional way.

Horizontal Excess Coverage eliminates most of the transaction costs that an insured would typically incur in purchasing insurance because it does not require lengthy or expensive underwriting and loss adjustment processes the way insurance does. As a result, it also eliminates more than 75% of the transaction costs that insurers typically have. These cost include sales, underwriting, and loss adjustment expenses and amount to approximately forty percent of property/casualty premium dollars in the United States. Reducing these costs increases profits for coverage sellers and enables them to reduce premiums for coverage buyers.

Horizontal Excess Coverage is extremely versatile from a contractual perspective and may be structured as an insurance policy or as some other type of contract. This is important because it enables companies and individuals that are not licensed as insurers to provide this coverage.

By substantially eliminating the underwriting and loss adjustment processes that are necessary to provide insurance-type coverage and by reducing the licensing limitations of insurance regulation, Horizontal Excess Coverage reduces barriers to entry and enables companies other than primary insurers to finance the risk of collateral losses. This gives insurance buyers access to new sources of risk capital and is particularly valuable in “hard” insurance markets when prices are high and coverage is difficult to obtain.

There are an infinite variety of ways to define the mathematical relationship between the price and coverage of Horizontal Excess Coverage in relationship to the premium paid for and the losses recovered under a separate insurance policy. This is useful because it enables coverage buyers and sellers to create risk transfer products that are tailored to their own specific needs.

Horizontal Excess Coverage also permits access to cheaper sources of capital than any other existing financial alternative. This is because individual insurers exhibit much greater loss volatility than does the insurance industry as a whole. By offering Horizontal Excess Coverage to the insureds of many different insurers, a coverage provider can mimic the loss experience of the industry and reduce its loss volatility. This will diminish the amount of capital that is needed to finance this risk while making the coverage providers significantly more attractive to investors since higher returns and lower profit volatility is exactly what investors want. These benefits can then be shared with coverage buyers in the form of lower premiums.

Furthermore, Horizontal Excess Coverage permits entities other than the insured to gain coverage based on insurance that someone else has. This might make sense in a situation where a company is highly dependent on a supplier and desires some collateral loss protection if the supplier sustains an insurable loss that would impair its ability to fulfill its contractual obligations.

Further objects and advantages are to provide a cheap, efficient, and convenient means of providing insurance buyers with an effective means of loss expense coverage. Other objects and advantages will become apparent from a consideration of the ensuing description and drawings.

### SUMMARY

This method permits the selection of loss expense coverage, underwriting, and loss determination processes of insurance to be performed by reference to an insurance policy.

### DRAWINGS

### Figures

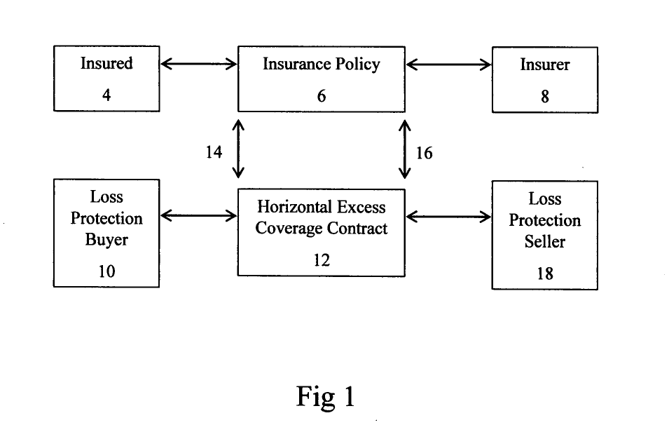

FIG. 1 shows a Horizontal Excess Coverage Contract that bears a functional relationship between its premiums and the premiums paid for an insurance policy as well as a functional relationship between the losses paid by the Horizontal Excess Coverage Contract and the losses paid by an insurance policy.

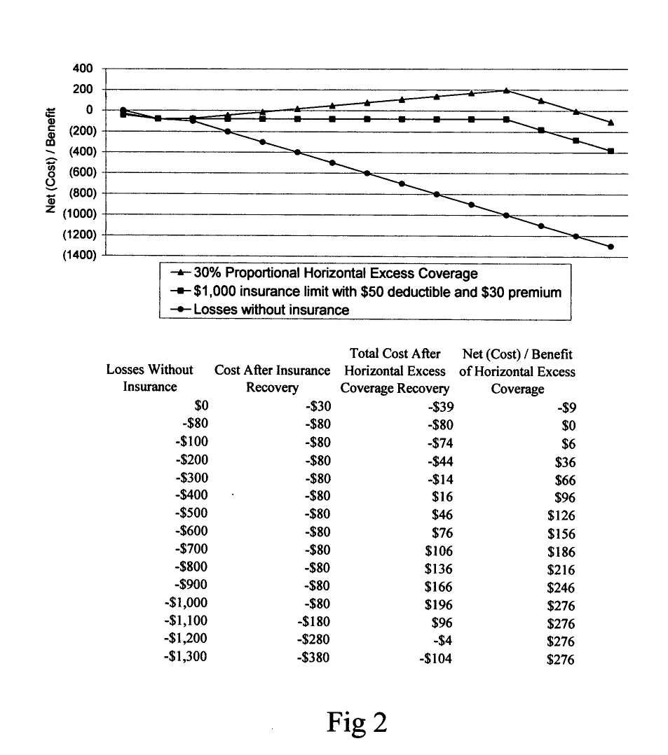

FIG. 2 is a chart and table that demonstrates the relationship between a 30% Proportional Horizontal Excess Coverage Contract and an insurance policy and shows the costs and benefits of this coverage.

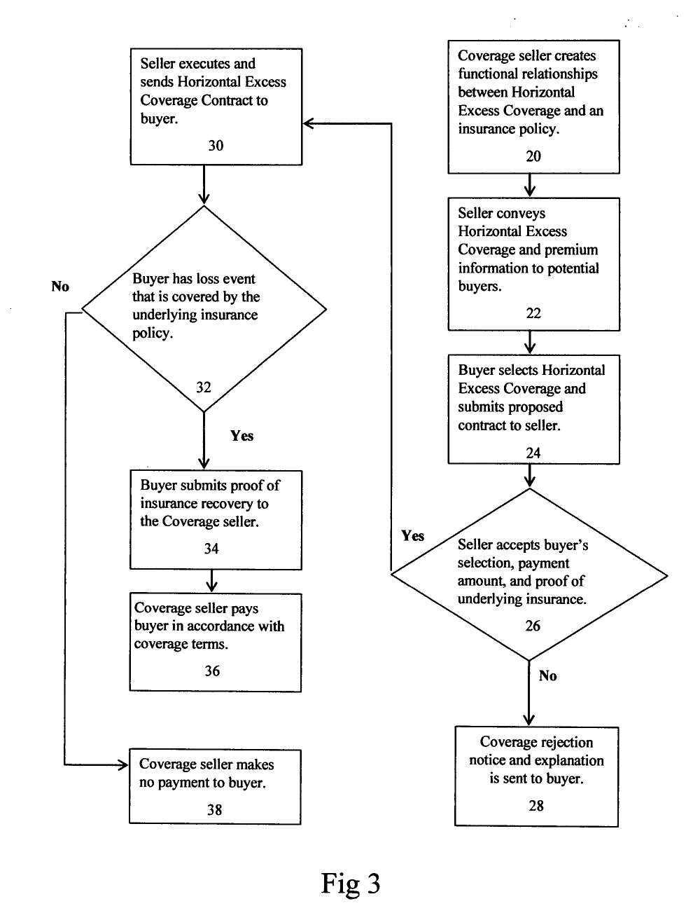

FIG. 3 is a flowchart that demonstrates how simple and cost effective it is to perform underwriting and loss adjustment functions when a Horizontal Excess Coverage Contract bears functional relationships to the premiums of the underlying insurance policy and the losses recovered under that policy.

### DETAILED DESCRIPTION

### FIGS. 1-3

### Preferred Embodiment

Product Overview

FIG. 1 shows how a Horizontal Excess Coverage Contract's premiums and loss payment may be related to the premiums paid for and the losses recovered under an insurance contract. It also shows the various parties to these contracts. An insured 4 has an insurance policy 6 with an insurer 8. The insurance policy may have one or more coverage parts and may specify various deductibles, retentions, limits, coinsurance, and exclusions. A loss protection buyer 10, also referred to as a coverage buyer or buyer, may be the insured or another entity that has an interest in the well-being of the insured, such as a customer of the insured. The coverage buyer may desire to buy loss protection via the Horizontal Excess Coverage Contract 12.

The Horizontal Excess Coverage Contract has two pre-specified functional relationships to the insurance policy: the contract's loss payment 14 is a mathematical function of the losses that are recovered under the insurance policy; and the contract's premiums 16 are a mathematical function of the insurance policy's premiums. Although this relationship may be expressed in many different ways, it must give the buyer value and allow a loss protection seller 18, also referred to as the coverage seller or seller, to make money.

The loss protection seller 18 may be the same as the insurer 8 or may be some other entity that is interested in providing Horizontal Excess Coverage.

Some basic pricing and coverage rules describe how these criteria can be met. The value of Horizontal Excess Coverage is always established provided that the price of this coverage is the same as or less than the separate insurance coverage on a dollar of premium for dollar of insured limit. In essence, an insured has indicated that this coverage has value at this price by its willingness to pay this premium for the underlying insurance.

Thus, if the underlying insurance coverage is $10 million and cost $1 million, Horizontal Excess Coverage can be sold at a ratio of $10 of limit to $1 of premium and provide value to a protection buyer. In certain circumstances Horizontal Excess Coverage may be of much greater value than this relationship suggest. In which case, a higher Horizontal Excess Coverage premium could be charged and still provide value to the buyer. For example, in “hard market” conditions or in cases where loss costs are particularly difficult to determine, Horizontal Excess Coverage may be significantly more valuable to coverage buyer than the ratio of insured limit to premium on the underlying insurance policy. In this case, a coverage seller might offer the coverage described above at a ratio of $10 of limit for $1.30 of premium, and it would still have significant value to the coverage buyer.

Because it can reduce underwriting and loss adjustment expenses by more than 75%, Horizontal Excess Coverage can be sold at a substantial discount to an underlying insurance policy and still provide value to both coverage buyers and coverage sellers. Assuming that underwriting and loss expenses are approximately 40% of insurance premiums, as they typically are for most US property/casualty insurance, a Horizontal Excess Coverage seller could reduce its premium rate by 30% in relation to the underlying insurance and still earn the same rate of return that the insurance company would earn on the underlying insurance policy. Using this assumption, the coverage provider in the example above could offer this coverage at a ratio of $10 of limit for $0.70 of premium.

Because Horizontal Excess Coverage substantially eliminates traditional insurance transaction costs, it reduces important barriers to entry in the insurance market and allows new entities to offer this type of coverage.

Cost/Benefit Analysis

FIG. 2 shows an example of Horizontal Excess Coverage and illustrates its cost and benefits in relation to an insurance policy. In this example, an insured is concerned about insured losses that might range from $0 to $1000. The insured recognizes that there are likely to be collateral losses that are uninsurable over this range of loss experience and would like to obtain coverage for them if possible. The insured has three choices.
a. Buy no insurance and suffer losses as they occur.
b. Purchase an insurance policy for a premium of $30 that contains a deductible of $50 and an insured limit of $1000.
c. Buy the insurance policy and supplement it by purchasing Horizontal Excess Coverage equal to 30% of the insurance policy on a proportional basis. This would cost 30% of the insurance policy's premiums, or an additional $9, and would pay 30% of any losses that are recovered under the insurance policy.
   The graph in FIG. 2 shows the net cost or benefit of each of these options over the relevant range of loss experience. The total cost or benefit equals the loss amount minus premiums and deductibles, plus any insurance and any Horizontal Excess Coverage loss payments.

The $30 cost of insurance premiums and the $50 deductible prevent the insurance option from breaking even until there has been at least $80 of insurable loss. This breakeven point for insurance would be higher to the extent that there are collateral losses that are not insurable. Putting aside the issue of collateral losses, the cost of the insurance premium and the presence of an insurance deductible make it impossible for the insurance buyer to ever be made whole by insurance. As a result, the line representing insurance will always be below the $0 line in the chart regardless of the specifics of a particular insurance policy.

The 30% proportional Horizontal Excess Coverage also provides significant benefits to the insured for insured losses that are greater than $80. However, as the loss experience gets worse, Horizontal Excess Coverage not only makes up for the premiums and the deductible that the insured paid, but also offers the ability to cover the additional collateral losses that the insured is concerned about. These losses cannot be covered in an economically feasible way by traditional insurance because they are too difficult to define in advance or to prove after the fact.

Method of Underwriting and Loss Adjusting

The flowchart in FIG. 3 illustrates how an entity that desires to sell Horizontal Excess Coverage could use this business method to eliminate most of the work that is currently required to underwrite loss coverage and to adjust claims. First, a coverage seller creates two functional relationships 20. One relationship defines the losses paid by Horizontal Excess Coverage in terms of the losses that will be recovered under an insurance policy and the second relationship defines the premium of the Horizontal Excess Coverage Contract in terms of the premiums paid for an insurance contract.

Next, the coverage seller communicates its willingness to offer coverage on these terms to potential buyers 22. For example, the following schedule might be used to communicate that the coverage seller is willing to provide Horizontal Excess Coverage on a basis that is proportional to the underlying insurance.

| Coverage | Price |
|---|---|
| 10% of insured loss recoveries | 10% of insurance premiums |
| 15% of insured loss recoveries | 15% of insurance premiums |
| 20% of insured loss recoveries | 20% of insurance premiums |
| 25% of insured loss recoveries | 25% of insurance premiums |
| 30% of insured loss recoveries | 30% of insurance premiums |

The coverage seller might use any type of communication medium to convey this information to potential buyers including: printed matter, radio, telephone, television, internet, intranet and other types of electronic communications.

Next, a buyer selects the most appropriate coverage amount based on her expectation of how much additional loss expense she might have over her insurance coverage and submits a proposed contract to the coverage seller for execution 24.

The coverage seller reviews the buyer's coverage submission request along with proof of the underlying insurance policy and payment 26. If there is something wrong with the submission, it would be rejected with an explanatory note sent back to the buyer 28. For example, the buyer may not have submitted proper proof that she had an insurance policy in force or may not have sent the proper payment amount.

Assuming the coverage submission is accepted, the coverage seller would send an executed contract to the buyer 30. This contract could be issued in the form of an insurance policy or some other type of contract.

If the Horizontal Excess Coverage buyer has a loss event 32, the buyer submits proof of the payment that it received from its separate insurance contract to the Horizontal Excess Coverage seller 34. The Horizontal Excess Coverage seller pays the buyer in accordance with the contract terms 36. If the buyer does not receive a payment under its insurance policy, the Horizontal Excess Coverage seller would make no payment to the buyer 38.

### Additional Embodiments

Although the most basic methodology for Horizontal Excess Coverage remains the same as described above, there are numerous embodiments of this concept. This method can be applied to all types of insurance policies including property, casualty, health, life, disability, workers' compensation, accident, etc. Furthermore, insurers may use this method to write a new policy or an endorsement to an existing policy so as to provide their customers with additional loss coverage.

This method also permits entities that are not involved in the original insurance policy to offer this coverage. Other insurers, banks, or other types of companies may find it advantageous to offer this type of coverage. Moreover, this method enables companies to provide loss coverage in the form of an insurance policy or any other type of contract.

Also, Horizontal Excess Coverage lends itself to many different business models. One might predefine acceptable combinations of loss payments and premiums and communicate this information to potential buyers so as to substantially reduce transaction expenses. However, this is not necessary to make Horizontal Excess Coverage valuable and worthwhile. Coverage sellers could just indicate their willingness to offer this type of coverage, and set their premiums on a case by case basis as they do with traditional insurance.

Horizontal Excess Coverage also offers tremendous flexibility in defining the qualitative dimensions of the loss payments from which it will be derived. Horizontal Excess Coverage may be based on a “coverage subset” of the insurance policy by further limiting the qualitative characteristics of the loss payments to which the mathematical function will be applied. For example, the Horizontal Excess Coverage might exclude certain coverage parts, types of coverages, or perils to limit the loss payments on which the Horizontal Excess Coverage will be based. Exclusions or other types of qualitative coverage limitations may be based on many other factors as well.

In addition to limiting the loss payments from a qualitative perspective by defining a coverage subset on which the Horizontal Excess Coverage loss function will be based, there are limitless mathematical functions that can be applied to the insured loss payments that are specified. Implicit in the application of a mathematical function is some relevant range of loss payments that are specified in the Horizontal Excess Coverage contract.

This relevant range can be all losses paid by an insurance policy or a specified coverage subset of an insurance policy, and it can be further limited by specifying additional quantitative limitations such as deductibles, retentions, and limits. Having specified the qualitative and the quantitative dimensions of the insured loss payments to which the Horizontal Excess Coverage applies, one can then specify a mathematical relationship that will determine how much the Horizontal Excess Coverage will pay.

This mathematical function may be structured so that the Horizontal Excess Coverage is “proportional” or “nonproportional.” This coverage is proportional if it specifies a constant percentage of Horizontal Excess Coverage for every dollar of insured loss recovery within the relevant range so that the payment is scaled based on the size of the specified insurance payments. For example, one might specify that the Horizontal Excess Coverage payment will be 10% of a particular property insurance policy's payments made under Coverage A, excluding losses from hurricanes, less a $5,000 deductible, and subject to a limit of $5 million.

Nonproportional Horizontal Excess Coverage may specify a binary relationship, i.e. if there are insured loss recoveries within the relevant range, a particular sum of money will be paid. For example, the contract may state that if there is a full-limit or total loss paid by the insurance policy, the Horizontal Excess Coverage will pay $10 million.

Alternatively, nonproportional Horizontal Excess Coverage may be scaled based on the size of the insured losses recovered within the relevant range. For example, one might specify loss coverage that pays nothing for the first $100 thousand of specified insurance loss recoveries, pays 10% of insurance loss recoveries between $100 thousand and $1 million, and then pays 20% of insurance loss recoveries subject to a limit of $2 million loss coverage.

Advantages

From the description above it should be clear that this process satisfies many purposes that can not be accomplished via traditional insurance or any other financial technique, operation, or type of contract that is currently in use to fund additional loss expenses. By simplifying the insurance process, this method reduces the costs that are currently part of the insurance process by as much as 75%, eliminating the need:
(a) To define coverage in terms of loss events;
(b) To separately underwrite each risk;
(c) For an extensive and cumbersome sales process;
(d) For proof of actual losses; and
(e) For a lengthy or disputatious claims adjustment process by the coverage provider.

This methodology also:
(f) Permits buyers to receive coverage for losses that are currently difficult or impossible to insure;
(g) Allows entities to select the amount of coverage and relationship to underlying loss experience that best suits their needs;
(h) Allows insurers to offer a new form of coverage to their customers;
(i) Permits the coverage to be structured as insurance or as some other type of financial contract;
(j) Gives insurance buyers access to new sources of capital by permitting third parties to offer them coverage;
(k) Reduces the costs of coverage for both providers and insurance buyers permitting significant premium reductions;
(l) Permits non-insurers to offer loss coverage; and
(m) Introduces more price competition to the insurance market by reducing the huge infrastructure costs that have been necessary to offer coverage to insurance buyers.

Although the description above contains certain specifics, these should not be construed as limiting the scope of the invention but as merely providing illustrations of some of the presently preferred embodiments of this invention. Clearly this methodology can be applied in many ways to all types of insurance and can be structured as insurance or as other types of financial contacts or separate provisions of other contracts. Thus the scope of the invention should be determined by the appended claims and the legal equivalents, rather than by any particular example described above.

1-25. (canceled)

26. A method for constructing a contractual payment provision, comprising the steps of:
a. specifying a casualty, life, health, disability, or workers' compensation insurance policy;
b. expressing said contractual payment as a mathematical function of the losses paid under said insurance policy;
c. incorporating said payment provision in a contract where the loss protection buyer is someone other than an insurer or a reinsurer.

27. The method of claim 26 where said contractual payment is expressed as a mathematical function of the losses paid by a coverage subset of said insurance policy.

28. A method for constructing a contractual payment provision, comprising the steps of:
a. specifying an insurance policy;
b. expressing said contractual payment as a proportional mathematical function of the losses paid under said insurance policy;
c. incorporating said payment provision in a contract where the loss protection buyer is someone other than an insurer or a reinsurer.

29. The method of claim 28 that is used to construct any type of non-insurance contract.

30. The method of claim 28 where said contractual payment is expressed as a mathematical function of the losses paid by a coverage subset of said insurance policy.

31. The method of claim 28 that specifies a particular property insurance policy that includes business interruption and extra expense coverage.

32. The method of claim 28 that specifies a particular casualty insurance policy sold to a company.

33. The method of claim 28 that specifies a particular property or casualty insurance policy sold to an individual.

34. The method of claim 28 that specifies a particular life, health, or disability insurance policy sold to an individual.

35. The method of claim 28 where the loss protection seller is someone other than the insurer that underwrote said insurance policy.

36. The method of claim 28 where said loss protection buyer is someone other than the insured on said insurance policy.

37. A method for constructing a contractual payment provision, comprising the steps of:
a. specifying an insurance policy;
b. expressing said contractual payment as a non-proportional mathematical function of the losses paid under said insurance policy;
c. incorporating said payment provision in a contract where the loss protection buyer is someone other than an insurer or a reinsurer.

38. The method of claim 37 that is used to construct any type of non-insurance contract.

39. The method of claim 37 where said contractual payment is expressed as a mathematical function of the losses paid by a coverage subset of said insurance policy.

40. The method of claim 37 that specifies a particular casualty insurance policy sold to a company.

41. The method of claim 37 that specifies a particular property insurance policy sold to a company.

42. The method of claim 37 where the loss protection seller is someone other than the insurer that underwrote said insurance policy.

43. The method of claim 37 where said loss protection buyer is someone other than the insured on said insurance policy.

44. A method for predefining acceptable combinations of loss payments and premiums, comprising the steps of:
a. specifying a type of insurance policy; and
b. expressing said acceptable combinations as a mathematical function of the losses paid by and the premiums paid for said type of insurance policy.

45. The method of claim 44 that is used to construct any type of non-insurance contract.

46. The method of claim 44 where said acceptable combinations are expressed as a mathematical function of the losses paid by and the premiums paid for a coverage subset of said insurance policy.

47. The method of claim 44 that specifies a type of casualty insurance policy sold to a company.

48. The method of claim 44 that specifies a type of property insurance policy sold to a company.

49. The method of claim 44 that specifies a type of insurance policy sold to an individual.

50. A method for pre-negotiating acceptable combinations of loss payments and premiums, comprising the steps of:
a. specifying a type of insurance policy;
b. expressing said acceptable combinations as a mathematical function of the losses paid by and the premiums paid for said type of insurance policy; and
c. using a means of communicating said acceptable combinations to potential coverage buyers.
